(19) United States
(12) Patent Application Publication
(10) Pub. No.: US 2005/0207194 A1
(43) Pub. Date: Sep. 22, 2005

(54) Control device and process of a converter and converter and electrical installation comprising such a device

(75) Inventors: Philippe Baudesson, La Buisse (FR); Francois Bouvet, Grenoble (FR)

Correspondence Address: PARKHURST & WENDEL, L.L.P., 1421 PRINCE STREET, SUITE 210, ALEXANDRIA, VA, 22314-2805, US

(73) Assignee: Schneider Electric Ind. SAS, Rueil Malmaison (FR)

(21) Appl. No.: 11/070,088

(22) Filed: Mar. 3, 2005

(30) Foreign Application Priority Data
Mar. 22, 2004 (FR) 0402921

(51) Int. Cl. H02M 3/335

(52) U.S. Cl. 363/98

(57) ABSTRACT

The control device of a converter comprises a control circuit for controlling power semi-conductors to supply from a power supply at least one pulsed voltage to an electric load connected to said converter by at least two conductors of at least one power supply line. The circuit controls power semi-conductors to supply on conductors of the line a first pulsed voltage having a first front then a second front after a preset time delay to compensate voltage reflection effects on said line, said time delay being comprised between one and three times a propagation time of a voltage front on said line. A converter and an installation comprise such a control device. A process comprises steps to supply voltage pulses with said fronts.

### BACKGROUND OF THE INVENTION

The invention relates to a control device of a converter comprising means for controlling power semi-conductors to supply from a power supply at least one pulsed voltage to an electric load connected to said converter by at least two conductors of at least one power supply line.

The invention also relates to an electric converter comprising:
a DC voltage supply,
power semi-conductors connected between the DC voltage supply and at least one load supply output line,
means to supply a median DC voltage of a value situated between a negative voltage value and a positive voltage value, and
such a control device.

The invention also relates to an electric installation comprising such a converter, an electric load to receive a pulsed voltage supplied by said converter, and an electric line to connect said electric load to the converter.

The invention also relates to a control process of a converter to supply a pulsed voltage to an electric load.

### STATE OF THE PRIOR ART

A converter 1 of speed variator type for an electric motor 2 such as the one represented in FIG. 1 comprises power semi-conductors 3 to chop a DC electric voltage Vc in pulse width modulation. The structure of such a converter is generally composed of a rectifier or a power supply 9 having an input connected to an AC mains line and an output supplying at least one DC or rectified voltage VC to an inverter or a chopper comprising power semi-conductor legs 3. On output of the legs, a power supply line 4 is connected to an electric load 2 of the synchronous or asynchronous motor type to supply a pulsed electric voltage. A control device 5 of the converter controls turn-on and turn-off of the semi-conductors.

In the case of converters connected to loads by long cables, in particular speed variation converters 1 connected to motors 2, disturbances generated by rising or descending fronts 6 and/or voltage fronts 7 can damage the electric components. For example, the electric stress to which insulators of the windings of a motor 2 located several meters from a speed variator are subjected is due to voltage fronts 6 and 7 having a very great voltage variation generated by a pulse width modulation converter 1. When the power supply line 4 has a cable of long length, the voltage surges due to the voltage front reflections on the load and the converter can be up to twice the converter DC supply voltage Vc. These voltage surges are also the consequence of the performances of the power semi-conductors which can easily switch the DC supply voltage in a rise time of less than a microsecond. FIG. 2 shows signals representative of voltage pulses VI of the converter and of voltage surges VR due to voltage reflections of said pulses. The voltage surges comprise oscillations due to the propagation rise and fall of the fronts on the line. The propagation rate on the line per unit length depends on the constitution of the power supply cables, and the reflection and attenuation rate depends on the load connected. The frequency of the oscillations is a function of the propagation time itself dependent on the length of the cables and on the propagation rate.

Repetitive voltage surges undergone by the windings of a motor cause premature aging of the insulators and consequently a large reduction of the lifetime of said motor.

In addition, voltage surges occurring on the motor, the voltage variations cause large electromagnetic disturbances.

It is known to use passive filters to limit the effects of voltage surges and disturbances. Passive filters fitted on the load or motor side reduce the voltage surges caused by the length of the power supply line cable. Passive filters fitted on the converter side reduce the voltage variations generated by chopping of the semi-conductors.

Load-side filters with inductance coils and capacitors are expensive and bulky due to the size of the passive components used. In addition, these filters are liable to cause resonances according to the load and certain frequencies of the converter. Another drawback of the filters concerns the cut-off frequencies which have to be tuned by changing components according to the loads. On the converter side, the filters limiting the voltage and current variation are less bulky but do however present the drawback of causing large losses due to the strong currents flowing through them.

### SUMMARY OF THE INVENTION

The object of the invention is to provide a converter control device and process enabling voltage surges due to switchings to be limited on a load and avoiding too bulky passive filters, as well as to provide a converter, and/or an electrical installation comprising such a device.

In a control device according to the invention, the control means control power semi-conductors to supply on conductors of the line a first pulsed voltage having a first front between a first low or zero value and an intermediate value, then a second front between said intermediate value and an amplitude value after a preset time delay to compensate voltage reflection effects on said line.

Preferably, said time delay is comprised between one and three times a propagation time of a voltage front on said line.

Advantageously, the time delay is comprised between 1.5 and 2.5 times the propagation time on said line. In particular, the time delay is substantially equal to twice the propagation time on said line.

Preferably, the intermediate value of the pulsed voltage is substantially equal to one half of the supply voltage.

In a preferred embodiment, the control means control power semi-conductors to stop supplying on conductors of the line a pulsed voltage having a third front between the amplitude value and an intermediate value then a fourth front between said intermediate value and a low or zero value after a preset time delay.

Preferably, the time delay on decrease is comprised between one and three times a propagation time of a voltage front on said line.

Advantageously, the control means comprise means for limiting the voltage variation of at least one of said fronts.

In a preferred embodiment, the means for limiting voltage variations control voltage variations to a first value on the first front and/or third front and to a second variation value lower than the first variation value on the second front and/or fourth front.

Preferably, the control device comprises means for determining a propagation time of a voltage front on a power supply line.

Advantageously, the control device comprises means for storing a value representative of a propagation time of a voltage front on a power supply line.

An electric converter according to the invention comprising:
a DC voltage power supply,
power semi-conductors connected between the DC voltage power supply and at least one load supply output line, and
means for supplying a median DC voltage of a value situated between a negative voltage value and a positive voltage value,
   comprises a control device as defined above to control the power semi-conductors.

An electric installation according to the invention comprises:
a converter comprising:
   a DC voltage power supply,
   power semi-conductors connected between the DC voltage power supply and at least one load supply output line, and
   means for supplying a median DC voltage of a value situated between a negative voltage value and a positive voltage value,
   an electric load supplied to receive a pulsed voltage supplied by said converter, and
an electric line to connect said electric load to the converter,
   the converter comprising a control device as defined above to control the power semi-conductors.

A control process of a converter according to the invention to supply a pulsed voltage to an electric load comprises:
a first voltage front step to supply a first voltage front between an initial value and an intermediate value,
a first delay step to introduce a time delay, and
a second voltage front step to supply a second voltage front between an intermediate value and a pulse amplitude value to compensate voltage reflection effects.

The control process preferably comprises:
a pulse duration step to make a pulse last during a pulse duration period,
a third voltage front step to cause a voltage reduction front between a pulse amplitude value and an intermediate value,
a second delay step to introduce a time delay, and
a fourth voltage front step to cause a voltage reduction front between an intermediate value and an initial value.

Advantageously, the first voltage front step, second voltage front step, third voltage front step and/or fourth voltage front step control the voltage fronts by limiting the voltage variation.

### BRIEF DESCRIPTION OF THE DRAWINGS

Other advantages and features will become more clearly apparent from the following description of particular embodiments of the invention, given for non-restrictive example purposes only, and represented in the accompanying drawings in which:

FIG. 1 represents a diagram of an installation comprising a converter of the prior art used as a speed variator to supply a motor;

FIG. 2 illustrates voltage signals and voltage fronts flowing on a power supply line caused by a converter of the prior art;

FIGS. 3A to 3C illustrate curves of voltage signals on a line connected to a converter according to a first embodiment of the invention;

FIG. 4 represents a block diagram of an installation comprising a converter according to an embodiment of the invention used as speed variator to supply a motor;

FIGS. 5A to 5C illustrate curves of voltage signals on a line connected by a converter according to a first embodiment of the invention;

FIGS. 6A to 6C illustrate curves of voltage signals on a line connected by a converter according to a second embodiment of the invention;

FIG. 7 illustrates a curve of a voltage signal supplied by a converter according to a first embodiment of the invention;

1a FIG. 8 illustrates a curve of a voltage signal supplied by a converter according to a second embodiment of the invention;

FIG. 9 illustrates a curve of a voltage signal supplied by a converter according to a third embodiment of the invention;

FIG. 10 represents pulse width modulation regulation signals in a device according to an embodiment of the invention;

FIG. 11 represents a diagram of a control device according to an embodiment of the invention to control a converter such as a speed variator;

FIGS. 12 and 13 represent flowcharts of processes according to embodiments of the invention;

FIGS. 14, 15 and 16 illustrate comparative curves of the voltages of a converter and of the voltages of the load respectively with a state-of-the-art device, with a device according to a first embodiment of the invention and with a device according to a second embodiment of the invention.

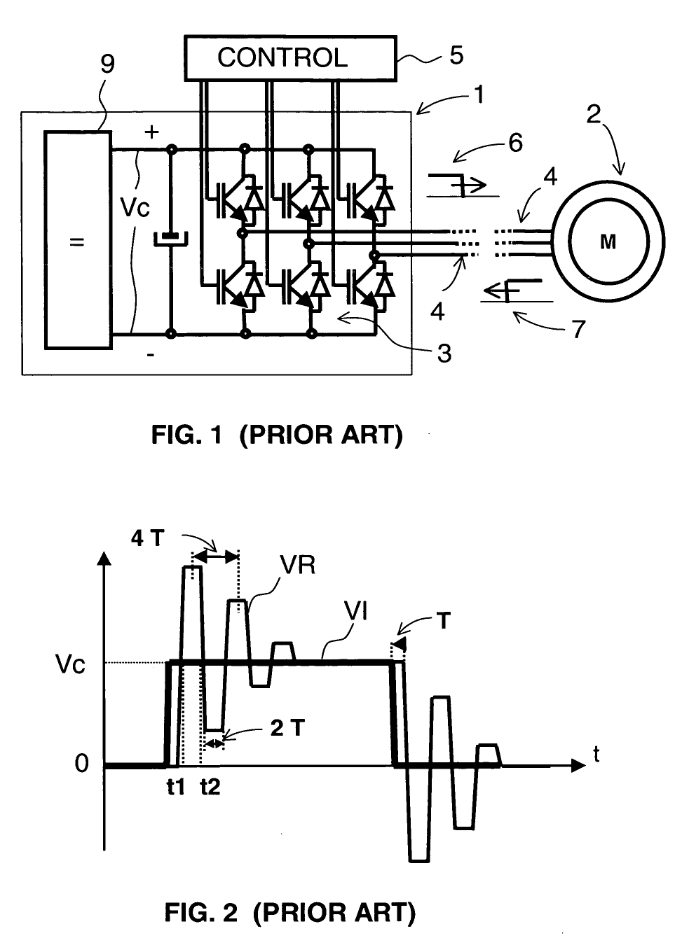

### DETAILED DESCRIPTION OF PREFERRED EMBODIMENTS

In a device according to an embodiment of the invention, a control circuit 5 controls semi-conductors 3 to supply on conductors of the line 4 a first pulsed voltage VI having on propagation a first rising front 10 between a low or zero value V0 and an intermediate value VM lower than a supply voltage VC, then a second rising front 11 between said intermediate value VM and a high value substantially equal to the supply voltage VC after a preset propagation time delay T2 less than twice a propagation time T on said line between said converter and a load.

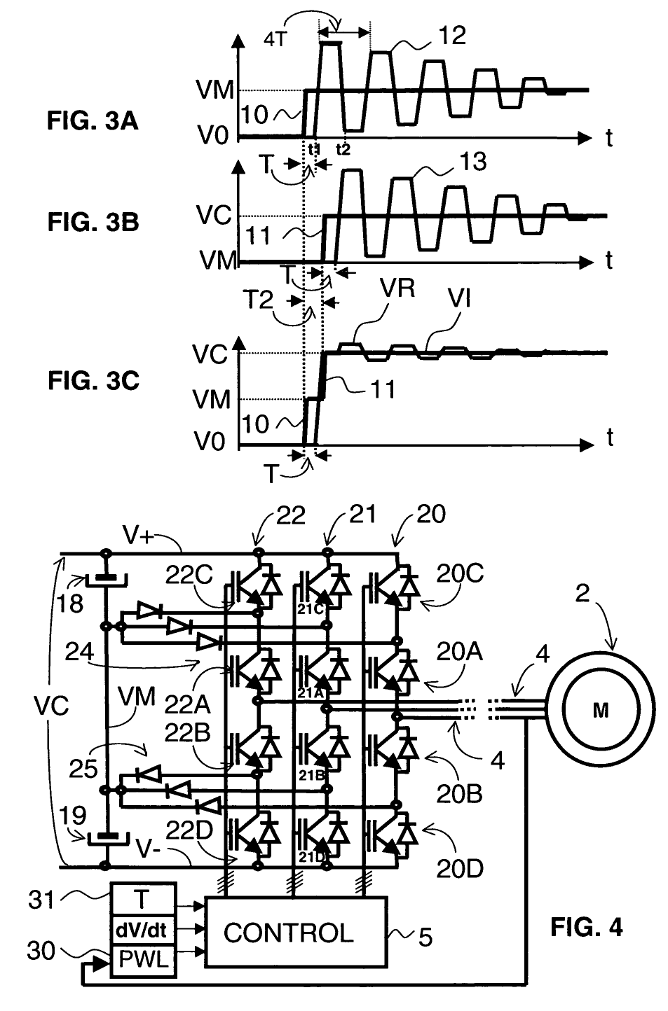

In the case of control of a motor by a speed variator, the impedance of the motor windings is higher than that of the line and the impedance of the converter is lower than that of the line, which means that the reflection is consequently positive with a maximum value of +1 on the motor side and the reflection is negative down to −1 on the converter side with voltage inversion. The rising front 10 represented in FIG. 3A generates oscillations 12 the frequency whereof is four times the propagation time T on the line. The amplitude is broken down by an increase of the voltage on the rise by reflection on the motor at a time t1, an inversion on descent by reflection on the converter at a time t2, and then a further reflection on the motor. In a device according to an embodiment of the invention, a second rising front 11 is applied with a time delay T2 of preferably about twice the propagation time as illustrated in FIG. 3B to correspond to a rise and fall of a front on the line. The second front 11 also generates oscillations 13 having similar characteristics to the oscillations 12 caused by the first front 10. The time delay T2 of the second front enables the oscillations and disturbances generated by the first front 10 to be compensated. FIG. 3C illustrates the combination of the first and second voltage front to constitute a load supply pulse VI. The pulse VI starting by two staggered rising fronts produces disturbances VR with greatly reduced voltage surges.

The time delay T2 between the two rising fronts is chosen between one and three times the propagation time T on the line between the converter and load, for example the motor. Preferably, the time delay T2 is comprised between 1.5 times and 2.5 times the propagation time T. For a very efficient compensation, the time delay T2 is advantageously chosen substantially around twice the propagation time T.

FIG. 4 shows the structure of a converter with a control device according to an embodiment of the invention. In this converter, a median voltage VM is generated on a common point of two capacitors 18 and 19 connected in series between the positive voltage V+ and negative voltage V− of the DC voltage VC. This converter comprises three legs 20, 21, 22 to produce a three-phase voltage which supplies a motor 2. Each leg comprises power semi-conductors enabling the first fronts and the second fronts to be supplied.

The fronts comprise three voltage levels in a rising or descending direction and of positive or negative polarity depending on the current sign output from each leg to a conductor of the line. Depending on the direction of the rising or descending front, the semi-conductors are turned on corresponding to the beginning of conduction and turned off to supply the three voltage levels.

In the case where the current output from the converter is positive, each leg comprises a semi-conductor 20A, 21A or 22A able to be turned on to supply a first positive intermediate voltage front VM via one of the diodes 24 and turned off to supply a second negative voltage front from the negative power supply line V− accessible by the diodes of the semi-conductors 20B-20D, 21B-21D or 22B-22D. Each leg also comprises a semi-conductor 20C, 21C or 22C able to be turned on to supply a second positive voltage front from the positive power supply line V+ and turned off to supply a first negative intermediate voltage front VM via one of the diodes 24.

In the case where the current output from the converter is negative, each leg comprises a semi-conductor 20B, 21B or 22B able to be turned on to supply a first negative intermediate voltage front VM via one of the diodes 25, and turned off to supply a second positive voltage front from the positive power supply line V+accessible by the diodes of the semi-conductors 20A-20C, 21A-21C or 22A-22C. Each leg also comprises a semi-conductor 20D, 21D or 22D able to be turned on to supply a second negative voltage front from the negative power supply line V- and turned off to supply a first positive intermediate voltage front VM via one of the diodes 25.

The semi-conductors are in particular field effect transistors, with insulated gate metal oxide or bipolar semi-conductors preferably with an integrated anti-parallel diode.

To combine the pulse fronts with compensation by staggering, the semi-conductors are preferably controlled by sequences. Thus, transistor 20C is turned on after transistor 20A with an offset time delay T2 and turned off before transistor 20A with an offset time delay T2. Likewise, transistor 20D is turned on after transistor 20B with an offset time delay T2 and turned off before transistor 20B with an offset time delay T2. The control sequences of the transistors of the other legs respectively 21C-21A, 21D-21B, 22C-22A and 22D-22B are performed in the same way.

In the embodiment of FIG. 4, the semi-conductors are preferably controlled in pairs. Thus, the control pulse of transistor 20C is the complement of the control pulse of transistor 20B give or take the time-out, the time-out being achieved by a delay on turn-on of transistor 20C and transistor 20B. Likewise, the control pulse of transistor 20A is the complement of the control pulse of transistor 20D give or take the time-out, the time-out being achieved by a delay on turn-on of transistor 20A and transistor 20D. The pairs of transistors of the other legs respectively 21C-21B, 21A-21D, 22C-22B and 22A-22D are controlled in the same way. The time-outs between the semi-conductor controls are independent from the time delay T2.

The intermediate voltage VM supplied on a common point of the capacitors 18 and 19 can also be regulated or balanced by components or circuits provided for this purpose.

In FIG. 4 the control circuit 5 controls the transistors according to pulse width regulation 30 and parameter setting 31 of a propagation time T.

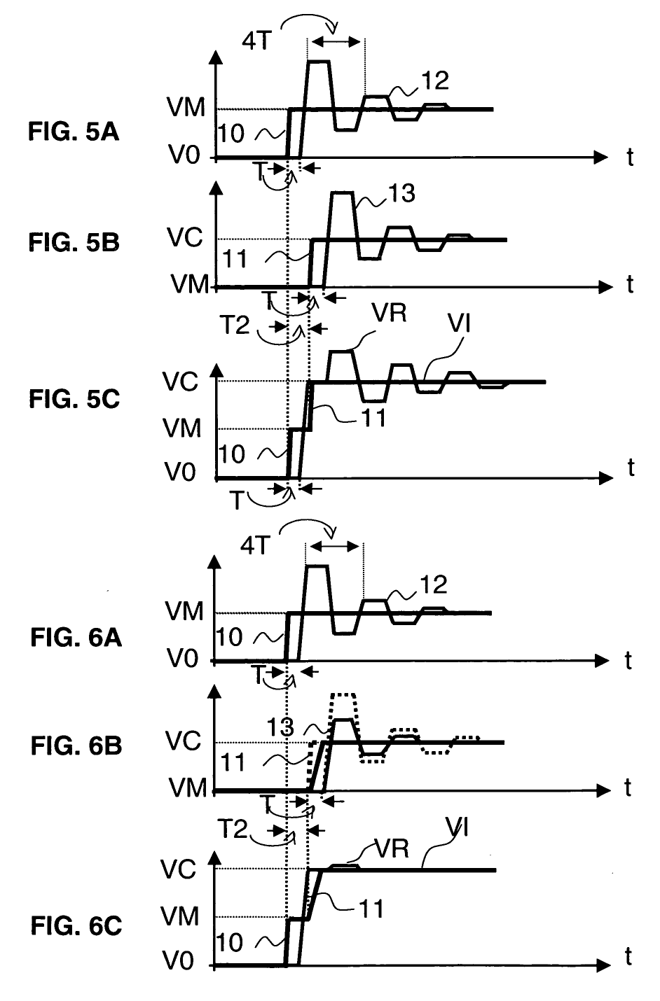

When reflection coefficients on the load side and/or converter side are not very high, for example when they are not close to +1 or −1 respectively, a few residual voltage surges may still remain which are not completely eliminated by compensation of two staggered fronts. As in FIGS. 5A to 5C, the oscillations 12 and 13 are quickly attenuated by bad reflection coefficients for example of about 0.6. There are then residual voltage surges VR on the pulse signal VI. These voltage surges are greatly reduced compared with those of FIG. 2 but they can advantageously be reduced.

In an advantageous embodiment of the invention, a control device comprises means for controlling the variation of the voltage fronts of the pulses. Advantageously, the voltage variation of the second front is smaller than the voltage variation of the first front. Thus, in FIGS. 6A to 6C a first front has a high voltage variation and generates oscillations of large amplitude quickly attenuated by a bad reflection, then a front 11 has a limited voltage variation represented by a slope in FIG. 6B. This variation generates oscillations of smaller amplitude adapted to compensate attenuated oscillations of the first front. The oscillations 13 produced by the second front 11 are also reduced due to the reduced variation of said second front. The combination of the fronts represented in FIG. 6C shows a pulse VI with a very low oscillation voltage surge VR.

Advantageously, consecutive fronts can also be used at the end of a pulse in particular to reduce oscillations and electromagnetic disturbances.

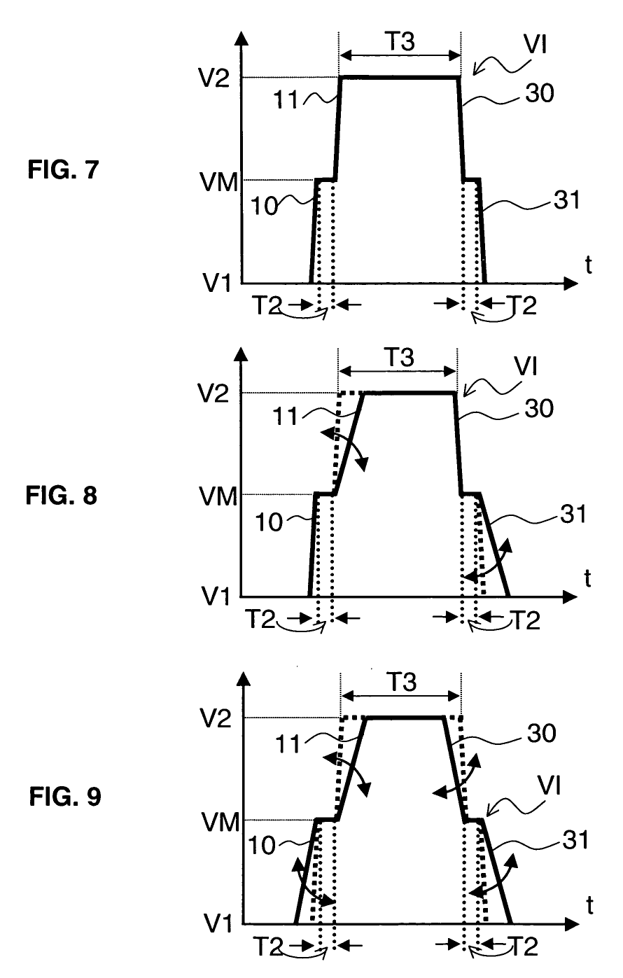

FIGS. 7, 8 and 9 show complete pulse width modulation pulses where the transistors of the legs are successively turned off and/or on depending on the direction of the current and of the voltage to be supplied in the line conductors. Thus, depending on the voltage to be supplied on the line the voltages V1, VM, and V2 are positive or negative.

In FIG. 7, the pulse VI starts by a first front 10 between a first low or zero value V1 and an intermediate value VM, followed by a second front between the intermediate value VM and a pulse amplitude value V2 delayed by a time delay T2, then during a pulse duration T3 the voltage remains at about V2. To end the pulse, a third front 30 reduces the voltage between the value V2 and an intermediate value VM, then after a time delay T2 a fourth front reduces the voltage between the intermediate value VM and a low or zero value V1.

In the preferred embodiment of FIG. 8, the signal comprises control of the voltage variation dv/dt on the second and fourth front to improve compensation when the reflections are not very good and to significantly reduce the conducted and radiated electromagnetic disturbances. To make reduction of the electromagnetic disturbances even more efficient, the pulse signal VI of FIG. 9 comprises a voltage variation control on all the fronts. Preferably, to minimize and distribute the losses in the semi-conductors equitably while preserving a high efficiency, the voltage variation of the second front is controlled so as to be less than that of the second front and the voltage variation of the fourth front is controlled so as to be less than that of the third front.

For example, the voltage variations of a first and/or third front can be greater than 5 kV/μs and the variations of the second and/or fourth front can be 1 to 5 kV/μs. Depending on the direction of the voltage, these preferred values can be positive or negative.

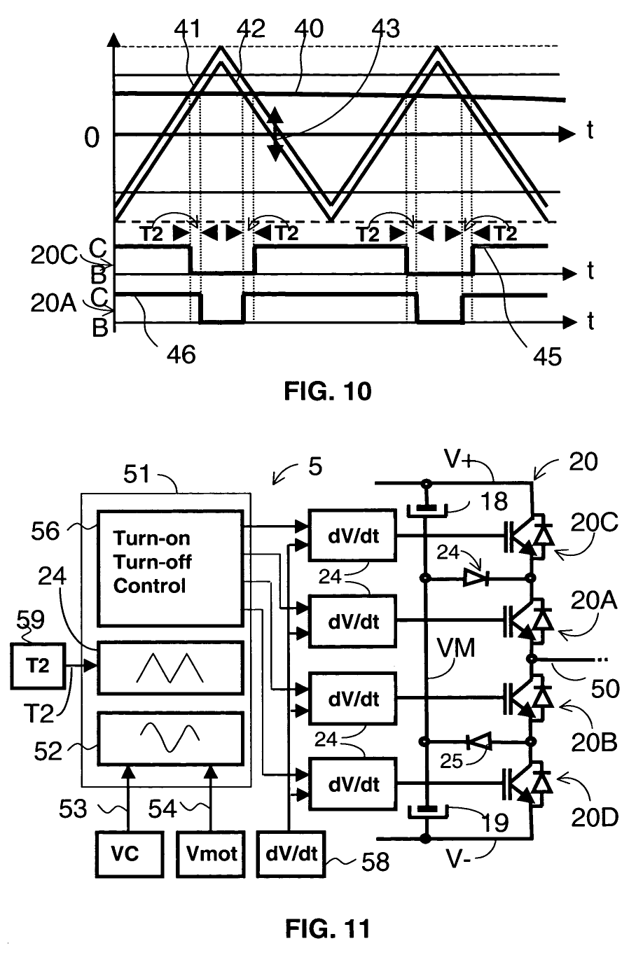

FIG. 10 shows pulse width modulation regulation signals in a device according to an embodiment of the invention. A curve 40 represents a reference signal notably a sinusoidal signal. Modulation signals 41 and 42 are compared with the reference signal 40 to command turn-off or turn-on of the power semi-conductors, in particular transistors 20C and 20A respectively represented by curves 45 and 46. An offset 43 between the modulation signals 41 and 42 enables a time delay T2 between the semi-conductor commands to supply successive voltage fronts.

A block diagram of a control circuit shows turn-on or turn-off control of a converter leg 20 to supply a voltage on a conductor 50 of a line. The control circuit comprises a pulse width modulation control circuit 51 with a regulation module 52 receiving supply voltage signals 53 and load voltage signals 54. A pulse width modulation module 55 receives signals from the regulation module 52 and signals representative of the time delay T2 to supply control signals to a power semi-conductor turn-on and turn-off control module 56. The module 56 supplies control signals to the power semi-conductors via voltage variation control circuits 57. Activation of voltage variation limiting is controlled by an activation circuit 58. Voltage values or variations can also be supplied by the circuit 58.

The value of the time delay T2 between a first front and a second front can be stored in a parameter setting circuit 59. The value of T2 dependent on a propagation time between the converter and load can be determined according to the characteristics of the line, by time measurement at the moment the installation is started up or automatically by a propagation time measurement device supplying a time value T.

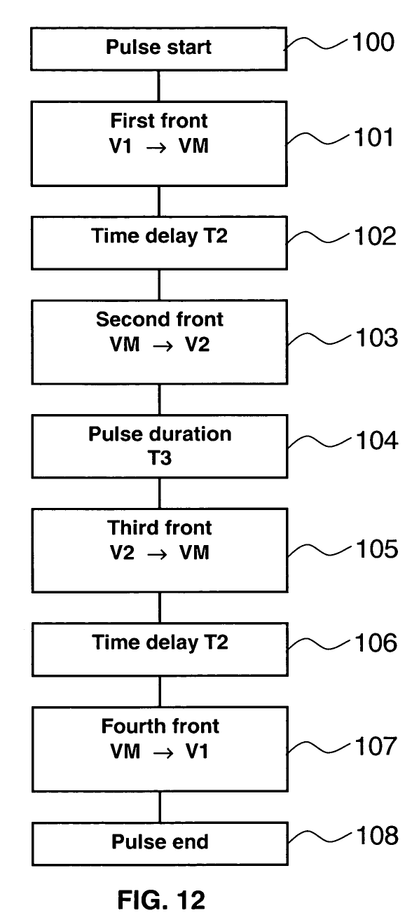

FIG. 12 represents a flowchart of a converter control process according to an embodiment of the invention. A step 100 defines the start of the pulse, then in a step 101 a first voltage front between an initial value V1 and an intermediate value VM is applied. Then, a time delay step 102 applies a time delay of value T2. Then, in a step 103 a second voltage front between an intermediate value and a pulse amplitude value V2 is applied. In a step 104, a pulse lasts for a period T3 defined by pulse width modulation. Then, in a step 105, a third front reduces the pulse between the value V2 and an intermediate value VM. Then, a time delay step 106 introduces a time delay T2, before a step 107 causes a fourth front reducing the voltage of the intermediate value VM to the value V1. A step 108 defines the end of the pulse.

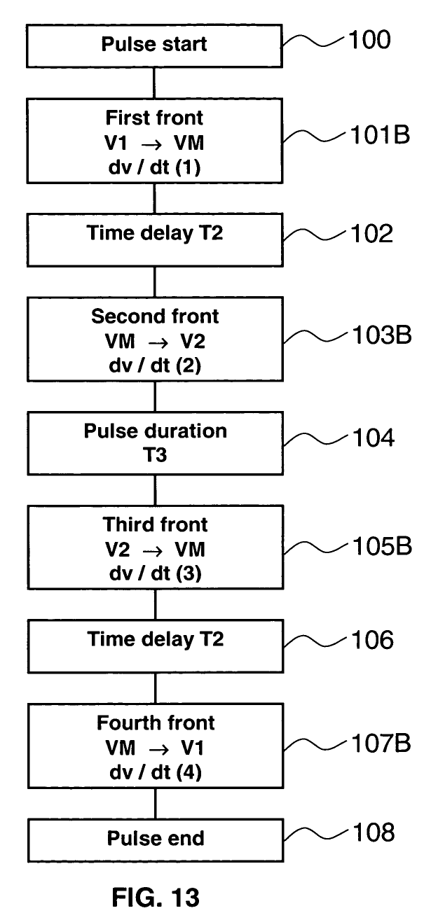

In FIG. 13 a flowchart represents a process where the steps 101, 103, 105 and 107 concerning fronts have been replaced by steps respectively 101B, 103B, 105B and 107B with the same functions and comprising in addition dv/dt voltage variation control.

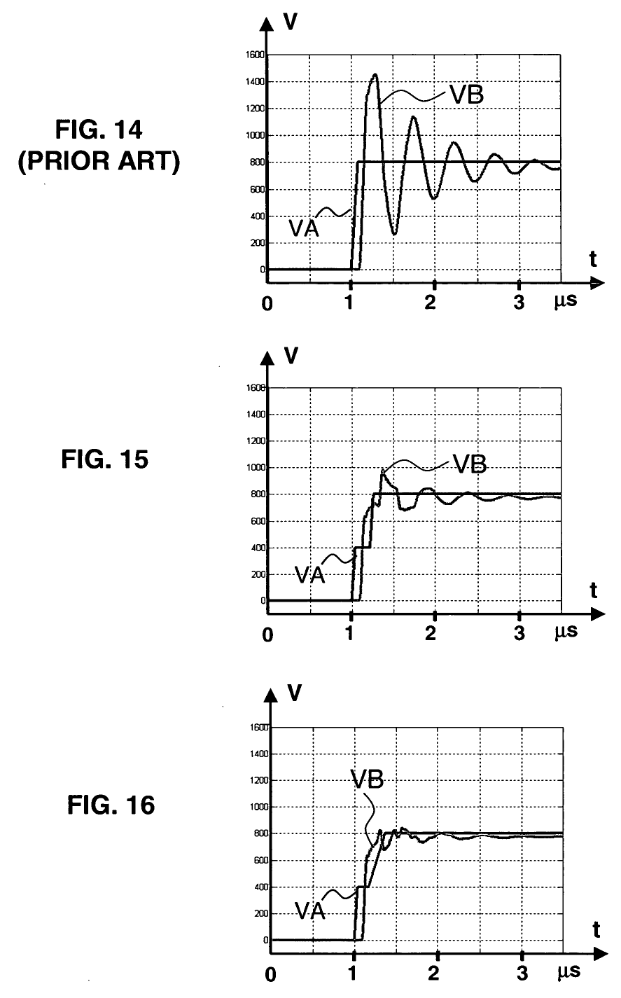

FIGS. 14, 15 and 16 show plots of the voltage signals VA on the converter side and VB on the motor side at the start of a pulse VI. In FIG. 14, the signals correspond to an installation of the prior art where there is a single voltage front. FIG. 15 shows signals with a device according to a first embodiment of the invention with two successive delayed fronts. FIG. 16 shows signals with a device according to a second embodiment of the invention with two successive delayed fronts and limiting of the voltage variation on the second front.

In the embodiments and figures described above the voltages are represented in positive manner but negative voltages are also concerned by the invention. The power semi-conductors can be of several types, for example bipolar transistors preferably with insulated gate, or field effect transistors.

The converters can be applied to several fields, in particular this invention is applied to speed variators for motors.

1. Control device of a converter comprising means for controlling power semi-conductors to supply from a power supply at least one pulsed voltage to an electric load connected to said converter by at least two conductors of at least one power supply line, wherein the control means control power semi-conductors to supply on conductors of the line a first pulsed voltage having a first front between a first low or zero value and an intermediate value, then a second front between said intermediate value and an amplitude value after a preset time delay to compensate voltage reflection effects on said line.

2. Device according to claim 1 wherein said time delay is comprised between one and three times a propagation time of a voltage front on said line.

3. Device according to claim 1 wherein the time delay is comprised between 1.5 and 2.5 times the propagation time on said line.

4. Device according to claim 1 wherein the time delay is substantially equally to twice the propagation time on said line.

5. Device according to claim 1 wherein the intermediate value of the pulsed voltage is substantially equally to one half of the supply voltage.

6. Device according to claim 1 wherein the control means control power semi-conductors to stop supplying on conductors of the line a pulsed voltage having a third front between the amplitude value and an intermediate value then a fourth front between said intermediate value and a low or zero value after a preset time delay.

7. Device according to claim 6 wherein the time delay on decrease is comprised between one and three times a propagation time of a voltage front on said line.

8. Device according to claim 1 wherein the control means comprise means for limiting the voltage variation of at least one of said fronts.

9. Device according to claim 8 wherein the means for limiting voltage variations control voltage variations to a first value on the first front and/or third front and to a second variation value lower than the first variation value on the second front and/or fourth front.

10. Device according to claim 1 comprising means for determining a propagation time of a voltage front on a power supply line.

11. Device according to claim 1 comprising means for storing a value representative of a propagation time of a voltage front on a power supply line.

12. Electric converter comprising:
a DC voltage supply,
power semi-conductors connected between the DC voltage supply and at least one load supply output line, and
means to supply a median DC voltage of a value situated between a negative voltage value and a positive voltage value,
comprising a control device according to the claim 1 to control the power semi-conductors.

13. Electrical installation comprising:
a converter comprising:
a DC voltage power supply,
power semi-conductors connected between the DC voltage power supply and at least one load supply output line, and
means for supplying a median DC voltage of a value situated between a negative voltage value and a positive voltage value,
an electric load supplied to receive a pulsed voltage supplied by said converter, and
an electric line to connect said electric load to the converter,
the converter comprising a control device according to the claim 1 to control the power semi-conductors.

14. Control process of a converter to supply a pulsed voltage to an electric load comprising:
a first voltage front step to supply a first voltage front between an initial value and an intermediate value,
a first delay step to introduce a time delay, and
a second voltage front step to supply a second voltage front between an intermediate value and a pulse amplitude value to compensate voltage reflection effects.

15. Control process according to claim 13 comprising:
a pulse duration step to make a pulse last during a pulse duration period,
a third voltage front step to cause a voltage reduction front between a pulse amplitude value and an intermediate value,
a second delay step to introduce a time delay, and
a fourth voltage front step to cause a voltage reduction front between an intermediate value and an initial value.

16. Control process according to claim 14 wherein the first voltage front step, second voltage front step, third voltage front step and/or fourth voltage front step control the voltage fronts by limiting the voltage variation.
